(19) United States
(12) Patent Application Publication
(10) Pub. No.: US 2009/0312049 A1
(43) Pub. Date: Dec. 17, 2009

(54) Context determination of an electronic device

(75) Inventor: Esa Pekka Isomursu, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 12/157,674

(22) Filed: Jun. 12, 2008

(51) Int. Cl. H04M 1/00

(52) U.S. Cl. 455/550.1

(57) ABSTRACT

A method and apparatus that features using haptics for actively probing the physical surrounding of a device, such as a mobile phone, and providing in response to the active probing a probable context of the device is presented. In one embodiment, a probing force is prepared and provided and imparted to the device. The displacement of the device relative to its physical surrounding in response to the probing force is sensed and a probable context is determined in response to the sensed displacement. In some embodiments, a context feedback signal indicative of the characteristics of the probable context is produced. In some embodiments, the device is configured for producing a haptic alert and for providing a haptic effect responsive to the haptic alert. In some embodiments the relative strength of a haptic alert is adjusted according to the determined probable context.

### BACKGROUND OF THE INVENTION

1. Field of the Invention

The present invention relates to the field of haptics.

More particularly, the present invention provides the active use of haptics for context recognition of an electronic device, and based on the information obtained identifying the probable context the needed strength of a haptic effect reflective of the context.

2. Description of Related Art

Sensory technology such as haptics has been used in gamepads and joysticks to provide a sense of reality or “being there” to enhance a user's enjoyment and experience in playing the game. These systems are based on force feedback technology and have been used in electronic devices such as for example mobile phones to extend the sensory experience to the user. Mobile phones use vibration to alert the user for example of an incoming call. The vibration in today's mobile phone is generally of a single strength and frequency. By varying the frequency of the vibration or by using multiple tones generated by the mobile phone, different haptic effects may be realized to deliver a more compelling and fin experience to the mobile phone user. For example, on a driving game, the mobile phone user would feel engine vibrations as well as the feeling of the car changing gears. On a shooting game, the mobile phone user would feel different sensations when firing and reloading. Integrating haptic actuators and haptics tones into the mobile phone enables the use of haptic effects ranging for example from alerts to music to explosions and other such sensory experiences and applications.

In order for a haptic alert in a haptic enabled device such as a mobile phone to be efficient, the device should know or take into account its physical surrounding so that a user would be made aware of a haptic alert in order to enjoy the haptic effect. For example, the mobile phone may be on a table, or as an earpiece in the user's ear, or in a pocket, or in a backpack and other such differing contexts. The context where the mobile phone is located can be detected by combining information from various sensors and applications that passively monitor the mobile phone's environment, however, the information that can be gathered is typically not 100 percent accurate and therefore the strength of the haptic alert may not be suitable to reflect the mobile phone's context.

In view of this, there is a need in the industry to solve the aforementioned context recognition problem in the art to adapt the strength of a haptic alert to reflect the context of the mobile device.

### SUMMARY OF THE INVENTION

The present invention provides a method and apparatus that features using haptics for actively probing the physical surrounding of a device, such as a mobile phone, and providing in response to the active probing a probable context of the device.

In a first broad aspect, the invention provides preparing a probing force for imparting a moving force to the device; providing the probing force for imparting the moving force to the device; sensing a displacement of the device relative to its physical surrounding in response to the moving force imparted to the device; and determining in response to the sensed displacement a probable context of the device. In some embodiments, the invention provides producing a context feedback signal indicative of the characteristics of the probable context of the device. In some other embodiments, the device is configured for producing a haptic alert and for providing a haptic effect responsive to the haptic alert. In some embodiments the invention provides adjusting the relative strength of a haptic alert according to the determined probable context of the device. In some embodiments, the invention provides increasing the strength of the haptic alert in response to a feedback signal indicative of the characteristic of the probable context of the device indicating a loose physical coupling between the device and its surrounding, and decreasing the strength of the haptic alert in response to a feedback signal indicative of the characteristic of the probable context of the device indicating a tight physical coupling between the device and its surrounding.

In a second broad aspect, the invention provides a device having one or more modules configured for actively probing the physical surrounding of the device, and one or more modules responsive to the active probing configured for providing a feedback signal indicative of the characteristics of the probable context of the device. In some embodiments, the device includes one or more preparing modules configured for preparing a probing force for imparting a moving force to the device; one or more modules configured for providing the probing force for imparting the moving force to the device; one or more sensing modules configured for sensing a displacement of the device in response to the moving force imparted to the device; and one or more determining modules configured for determining in response to the sensed displacement a probable context of the device. In some embodiments the device includes one or more haptic alert modules configured for producing a haptic alert, and one or haptic effect modules configured for providing a haptic effect. In some embodiments, the device includes one or more adjusting modules configured for adjusting the relative strength of a haptic alert in response to the determined probable context of the device. In some embodiments the device is a mobile communication device.

In a third broad aspect the invention provides a computer program product with a program code, which program code is stored on a machine readable carrier, for carrying out a method comprising actively probing the physical surrounding of a device, and providing in response to the active probing a feedback signal indicative of the probable context of the device when the computer program is run in a module of the device, such as a mobile communication device. In some embodiments, the invention provides implementing the actions of the method via a computer program running in a processor, controller or other suitable module in the device.

In a fourth broad aspect, the invention provides apparatus including means for actively probing the physical surrounding of the apparatus, means for providing in response to the active probing a probable context of the apparatus. In some embodiments, the apparatus provides means for preparing a probing force for imparting a moving force to the device; means for providing the probing force for imparting the moving force to the device; means for sensing a displacement of the device relative to its physical surrounding in response to the moving force imparted to the device; and means for determining in response to the sensed displacement a probable context of the device. In some embodiments the apparatus provides means for producing a haptic alert; means for providing a haptic effect; and means for adjusting the relative strength of a haptic alert in response to the determined probable context of the device. In some embodiments the apparatus is a mobile communication device.

### BRIEF DESCRIPTION OF THE DRAWINGS

The above and other features and advantages of the invention will become apparent from a consideration of the following detailed description presented in connection with the accompanying drawings, in which:

FIGS. 1 and 2 show a flowchart of the basic actions according to some embodiments of the present invention.

FIG. 3 shows a context recognition enabled device in the form of a mobile communication device according to some embodiments of the present invention.

FIG. 4 is a functional block diagram of a signal processor showing the major logical elements or modules for carrying out the intended functions according to some embodiments of the invention.

FIG. 5 is a schematic functional block diagram of a mobile communication terminal showing the major operational functional components to carry out the intended functions of the mobile communication terminal and implement the context recognition according to some embodiments of the invention.

### DETAILED DESCRIPTION

FIG. 1 shows a flowchart generally indicated by 10 having the basic steps or actions 10a and 10b for implementing the inventive method according to some embodiments of the present invention including actions in an electronic device such as for example a mobile communication terminal, for actively probing the physical surrounding of the device (step 10a); and providing in response to the active probing a probable context of the device (step 10b). The scope of the invention is not intended to be limited to the order in which the steps in FIG. 1 are performed and may be repeated as necessary to obtain the intended result for an increased accuracy in determining the probable context. These steps 10a, 10b may be implemented in one or more modules configured to do the same in such electronic devices such as for example mobile communication terminals or such like devices.

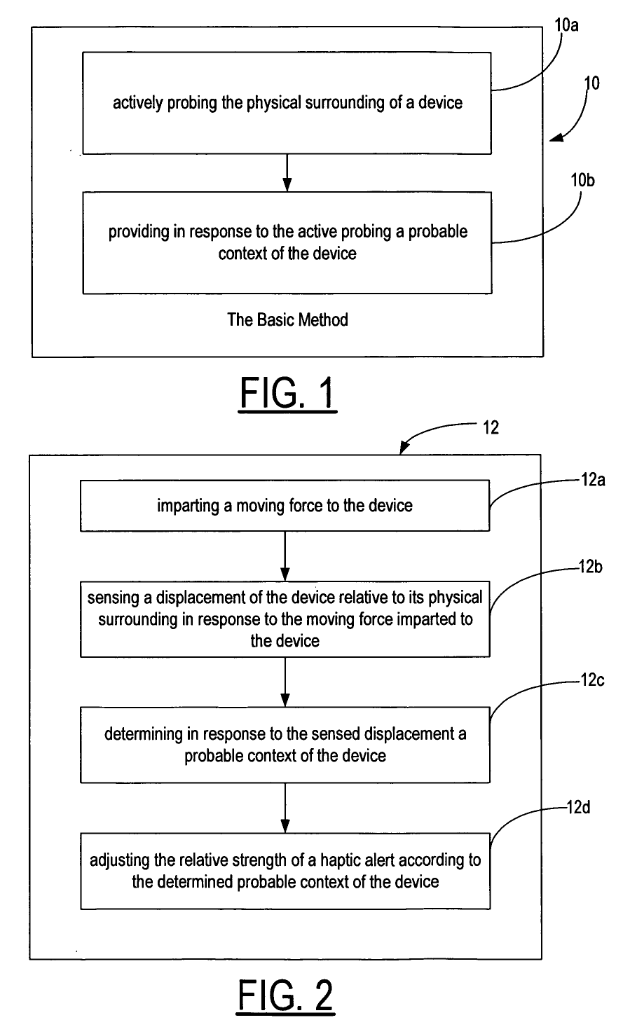

In addition, FIG. 2 shows a flowchart generally indicated by 12 having the basic steps or actions 12a-12 d for implementing the inventive method according to some embodiments of the present invention, including steps for imparting a moving force such as a vibration to the device (step 12a), sensing a displacement of the device relative to its physical surrounding in response to the moving force imparted to the device (step 12b), determining in response to the sensed displacement a probable context of the device (12c), and adjusting the relative strength of a haptic alert produced by the device according to the determined probable context of the device (12d). The scope of the invention is not intended to be limited to the order in which the steps in FIG. 2 are performed. For example, in FIG. 2 steps 12a-12c can be repeated as necessary to obtain the intended result for an increased accuracy in determining the probable context prior to adjusting the relative strength of a haptic alert (Step 12d). For example, the device may be vibrated slightly and its displacement or movement sensed. The movement of the device will be differentiated in accordance with its context. For example, the device will move differently on a hard table surface than if contained in a loose pocket or a tight pocket or on a user's ear. For purposes of gaining a fuller understanding and appreciation of the inventive concept of the present invention, an example of such a possible movement differentiation is movement on a table or hard surface would have or exhibit a one-sided movement or bouncing characteristic while movement in a pocket would have or exhibit a back-and-forth movement characteristic because there is no surface to restrain its relative movement in both directions.

A series or sequence of increasing strength vibrations could be used to sense the relative movement of the device. If the device responds with little or no displacement increase with increasing strength vibrations, this would be characteristic of a highly restrained context such as a tight pocket or other such tightly coupled situation. If the device responds with a large or increasing displacement increase with increasing strength vibrations, this would be characteristic of a loosely restrained characteristic such as a loose pocket or other such loosely coupled situation. Varying degrees of displacement in response to increasing vibrations would be characteristic of varying constraint contexts for example from a loose pocket to a tight pocket. A response characteristic could be empirically determined and stored in a look-up table for use by an appropriate algorithm for carrying out the method according to some embodiments of the invention. Similarly, these steps 12a-12d may be implemented in one or more modules configured to do the same in such electronic devices such as for example mobile communication terminals or such like devices.

It is understood that the aforementioned methods may include other steps known in the art that do not form a part of the underlying invention.

The scope of the invention is not intended to be limited to any of the aforementioned methods for context sensing and may be advantageously used with other methods to obtain more accurate results or information about a given context in the practice of those methods with which the inventive concept of the present invention may be used.

### Device Implementation

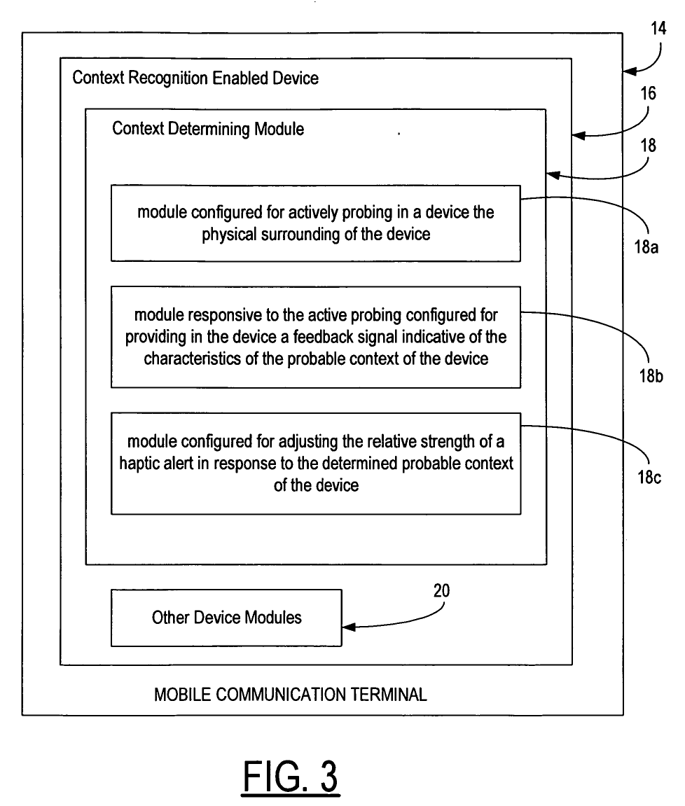

FIG. 3 shows by way of example, a mobile communication device generally designated as 14 in the form of a context recognition enabled device generally designated as 16 according to some embodiments of the present invention. The context recognition enabled device 16 has one or more context determining modules 18 including a module 18a configured for actively probing in the mobile communication device 14 the physical surrounding of the device 14, a module 18b response to the active probing of the device 14 configured for providing a feedback signal indicative of the characteristics of a probable context of the device 14, and a module 18c configured for adjusting the relative strength of a haptic alert in response to the determined probable context of the device.

Consistent with that described above, the context recognition enabled device 16 is shown in the form of a mobile communication terminal 14 or other suitable electronic device either now known or developed in the future for producing and providing haptic alerts and haptic effects. The context recognition enabled device 16 may also have other device modules 20 that do not necessarily form part of the underlying invention and are not described in detail herein.

### Implementation of the Functionality of Modules 18a-18c

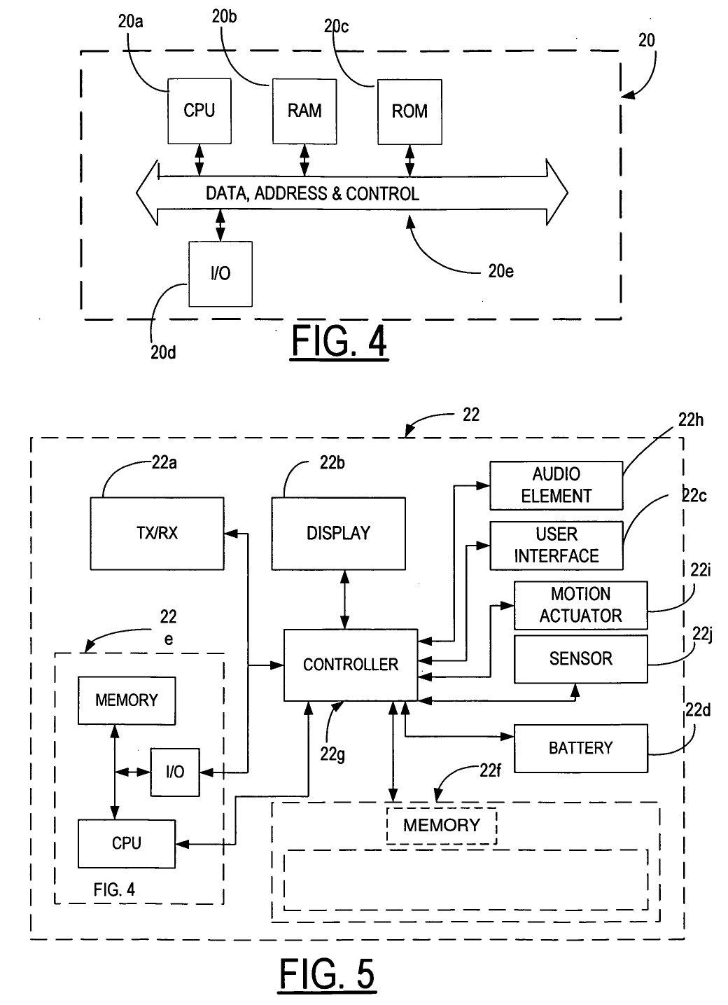

By way of example, and consistent with that described herein, the functionality of the modules 18, 18a, 18b and/or 18c may be implemented using hardware, software, firmware, or a combination thereof, although the scope of the invention is not intended to be limited to any particular embodiment thereof. In a typical software implementation, the modules 18a, 18b and 18c would be one or more microprocessor-based architectures such as for example a signal processor shown in FIG. 4 and generally designated by 20. The signal processor 20 shown in FIG. 4 includes a microprocessor or central processing unit (CPU) 20a, a random access memory (RAM) 20b, a read only memory (ROM) 20c, input/output devices 20d, and control, data and address busses 20e connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 18a, 18b and 18c being a standalone module, as shown, or in combination with other circuitry for implementing another module. Moreover, the real-time parts of the module may be implemented in hardware while the non-real time parts of the module may be done in software.

The other device modules 20 may also include other modules, circuits, devices that do no form part of the underlying invention per se. The functionality of the other modules, circuits, devices that do not form part of the underlying invention are known in the art and are not described in detail herein.

A schematic functional block diagram of a mobile communication terminal generally designated by 22 is presented by way of example in FIG. 5 showing the major operational functional components to carry out the intended functions of the mobile communication terminal and implement the context recognition according to some embodiments of the invention. The mobile communication terminal 22 includes a transmitter/receiver 22a, a display 22b, a user interface 22c, a battery 22d, an appropriate signal processor 22e such as shown in FIG. 4, a digital signal processor or other suitable processor to carry out the computational and operational control of the mobile communication terminal in accordance with one or more sets of instructions stored in a memory 22f and intended functions of the invention, for example, executing the algorithms of the method in accordance with the invention, analyzing the sensed data and carrying out the operational functions of the invention. An appropriate audio element 22h provides the tones according to the haptic effect to be delivered by the mobile communication device 22. A suitably arranged and configured motion actuator 22i such as for example, a vibrator, a piezo-electric device, eccentric weighted motor is used to impart a moving force to the device for active probing of its surroundings. A suitably arranged and configured sensor 22j such as for example, an accelerometer is used to measure the relative displacement of the device in response to the moving force imparted to the device. A controller 22g operates in a well-known manner to control the operation and functions of the various components of the mobile communication device. The functionality of the other modules, circuits, devices that do not form part of the underlying invention are known in the art and are not described in detail herein.

One or more appropriate control algorithms are required to handle the signaling related to the motion actuator 22i to control the intensity and/or frequency of the force of the motion imparted to the device. One or more appropriate algorithms are required to handle the displacement measurements related to the sensor 22j in determining a probable context of the device. One or more appropriate algorithms are required for adjusting the relative strength of a haptic alert according to the determined probable context of the device.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
actively probing the physical surrounding of a device, and
providing in response to the active probing a probable context of the device.

2. The method according to claim 1 further comprising:
preparing a probing force for imparting a moving force to the device;
providing the probing force for imparting the moving force to the device;
sensing a displacement of the device relative to its physical surrounding in response to the moving force imparted to the device; and
determining in response to the sensed displacement a probable context of the device.

3. The method according to claim 2 further comprising producing a context feedback signal indicative of the characteristics of the probable context of the device.

4. The method according to claim 3 wherein the device is configured for producing a haptic alert.

5. The method according to claim 4 wherein the device is configured for providing a haptic effect responsive to the haptic alert.

6. The method according to claim 4 further comprising adjusting the relative strength of a haptic alert according to the determined probable context of the device.

7. The method according to claim 6 further comprising increasing the strength of the haptic alert in response to a feedback signal indicative of the characteristic of the probable context of the device indicating a loose physical coupling between the device and its surrounding.

8. The method according to claim 6 further comprising decreasing the strength of the haptic alert in response to a feedback signal indicative of the characteristic of the probable context of the device indicating a tight physical coupling between the device and its surrounding.

9. A device, comprising:
one or more modules configured for actively probing the physical surrounding of the device, and
one or more modules responsive to the active probing configured for providing a feedback signal indicative of the characteristics of a probable context of the device.

10. The device according to claim 9 further comprising:
one or more preparing modules configured for preparing a probing force for imparting a moving force to the device;
one or more modules configured for providing the probing force for imparting the moving force to the device;
one or more sensing modules configured for sensing a displacement of the device in response to the moving force imparted to the device; and
one or more determining modules configured for determining in response to the sensed displacement a probable context of the device.

11. The device according to claim 10 further comprising one or more haptic alert modules configured for producing a haptic alert.

12. The device according to claim 10 further comprising one or more haptic effect modules configured for providing a haptic effect.

13. The device according to claim 11 further comprising one or more adjusting modules configured for adjusting the relative strength of a haptic alert in response to the determined probable context of the device.

14. The device according to claim 13 wherein the device is a mobile communication terminal.

15. A computer program product with a program code, which program code is stored on a machine readable carrier, for carrying out a method comprising actively probing the physical surrounding of a device, and providing in response to the active probing a feedback signal indicative of the probable context of the device when the computer program is run in a module of the device, such as a mobile communication terminal.

16. A method according to claim 1 wherein the method further comprises implementing the actions of the method via a computer program running in a processor, controller or other suitable module in the device.

17. Apparatus, comprising:
means for actively probing the physical surrounding of the apparatus, and
means for providing in response to the active probing a feedback signal indicative of a probable context of the apparatus.

18. Apparatus according to claim 17 further comprising:
means for preparing a probing force for imparting a moving force to the device;
means for providing the probing force for imparting the moving force to the device;
means for sensing a displacement of the device relative to its physical surrounding in response to the moving force imparted to the device; and
means for determining in response to the sensed displacement a probable context of the device.

19. Apparatus according to claim 18 further comprising;
means for producing a haptic alert;
means for providing a haptic effect; and
means for adjusting the relative strength of a haptic alert in response to the determined probable context of the device.

20. Apparatus according to claim 20 wherein the apparatus is a mobile communication device.
